(19) United States
(12) Patent Application Publication
(10) Pub. No.: US 2003/0167381 A1
(43) Pub. Date: Sep. 4, 2003

(54) System and method for dynamic memory access management

(76) Inventors: Israel Herscovich, Modiin (IL); Simoni Ben-Michael, Givat-Zeev (IL); Meir Tsadik, Hod-Hasharon (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 10/086,631

(22) Filed: Mar. 4, 2002

(51) Int. Cl. G06F 12/00

(52) U.S. Cl. 711/151; 711/163

(57) ABSTRACT

A shared memory access controller method and system utilize a load monitor unit able to monitor memory access requirements of one or more devices coupled to a memory. A load manager unit coupled to the load monitor unit is able to set an access policy for at least one of the devices in relation to data from the load monitor. There is also an access control unit connected to the load manager unit and able to provide a device access to the memory based on the device's associated access policy.

### BACKGROUND OF THE INVENTION

Digital memory units such as semiconductor memory chips, optical memory matrixes, and any other functionally equivalent structures are an essential part of data processing and communication systems. It would be beneficial to provide multiple devices access to a shared memory, such as an external memory subsystem, over at least one common bus or interface. Using a single common interface to a shared memory may cause conflicts between different devices having different memory access requirements. For example, with a common memory subsystem used for CPU program fetch, CPU data read/write and several fast DMA engines, the requirements of each device may vary as follows: (1) constant bandwidth for CPU program fetch, (2) low latency for CPU access which requires small burst transfer by DMA engine, and (3) on the other side, long bursts for DMA engines to minimize dead switching cycles and maximize effective bus bandwidth. Conflicting requirements may produce bottlenecks and/or inefficiencies in a system having a common memory sub-system.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawerings in which:

FIG. 1 is a diagram showing a system for managing access to a memory shared by a CPU, a first interface, and a second interface;

FIG. 2 is a diagram showing a memory access controller according to an embodiment of the present invention; and

FIG. 3 is flowchart showing the steps of a method of managing memory access according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculatng”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. Possible exemplary structures for a variety of these systems will appear from the description below. In addition, embodiments of the present invention are not described with reference to any particular programming language. It will be appreciated that a variety of programming languages may be used to implement embodiments of the present invention as described herein.

In an embodiment of the present invention, a shared memory access controller may monitor and regulate access to a shared memory by two or more devices sharing the memory. The controller may have a load monitor unit for monitoring memory access requests or requirements by devices operatively connected to the memory. The controller may also have a load manager unit operatively connected to the load monitor unit for dynamically setting an access policy for a device operatively connected to the memory, where the policy may be correlated to data from the load monitor. In an embodiment of the present invention, there may also be an access control unit operatively connected to the load manager unit for providing a device access to the memory, based on the device's associated access policy. It is noted that the present invention may comprise other components and may contain different combinations of hardware and software components. Furthermore, hardware components may be implemented in software and software components may be implemented in hardware.

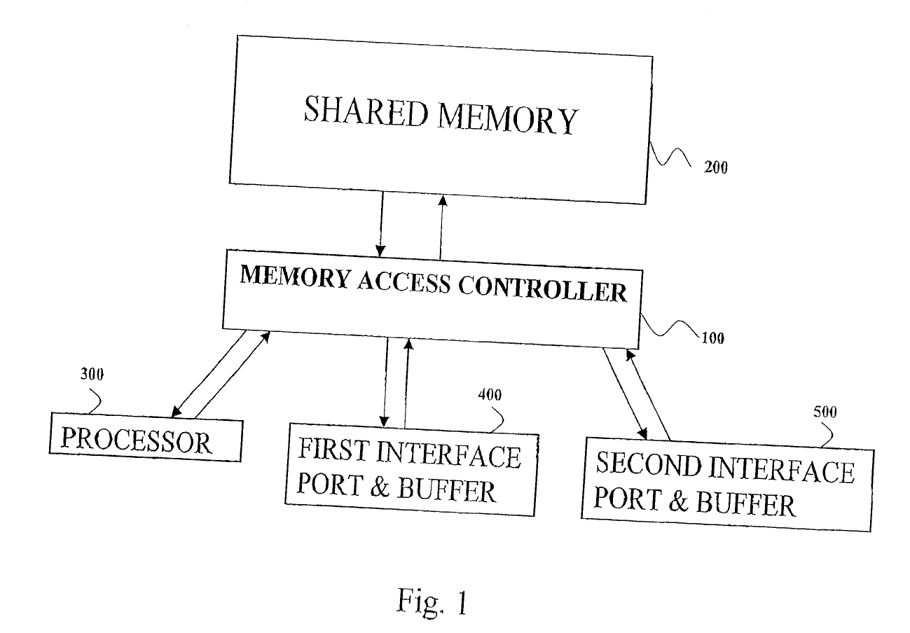

Turning now to FIG. 1, there is show a memory access controller 100 according to all embodiment of the present invention regulating access to a shared memory 200 by a processor 300, a first interface 400 and a second interface 500. Although the scope of the present invention is not limited in any by this, the shared memory 200 may be, for example, a dynamic random access memory (DRAM) or static random access memory (SRAM). Each of the devices may issue a request to either read or write to a portion of the memory 200. The devices may each utilize a Dynamic Memory Access unit (“DMA”). The size of the requested memory may be related to the device's specific requirements. For example, if the second interface 500 receives a large amount of data from an outside data source, it may request a larger portion of memory to which it may write the received data. If the processor 300 converts the data written by the second interface 500 into a compressed data format to be used by a data destination connected to the first interface 400, the first interface 400 may request access to a relatively smaller portion of the memory. The processor 300 may require more frequent access to the shared memory 200 than either the first or second interfaces, 400 and 500, and thus may have a higher priority level than either of them. It is noted that the present invention may comprise other components and may contain different combinations of components.

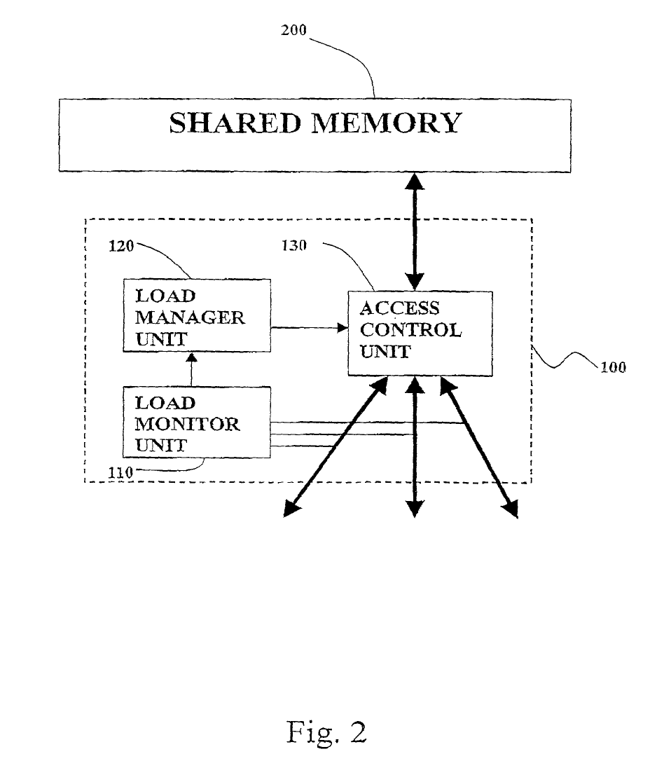

Turning now to FIG. 2, there is shown memory access controller 100 coupled to shared memory 200. The controller 100 may comprise a load monitor unit 110, a load manager 120 and an access control unit 130. The load monitor unit 110 may receive memory access requests or other related information from one or more devices sharing the memory 200. The load monitor unit 110 may convey the information or data to the load manager unit 120. The load manager 120 unit may dynamically set an access policy for each device. The access policy may, for example, define a memory access size value or a memory access time value. Each device's access policy may be based on its relative access request and/or requirement, Each device's access policy may also be based on the device's priority. For example, a device such as a computing device, whose computations may be required for efficient data flow through a system using an embodiment of the present invention, may have a relatively higher priority level, and thus may receive greater access to the shared memory than other devices having lower priority levels. The load manager 120 may change a device's access policy as the device's relative requirements change over time. It is noted that the present invention may comprise other components and may contain different combinations of components performing these functions. Furthermore, access policies may define different possibilities and access policies may be based on other factors.

The access control unit 130 may grant devices access to the shared memory 200 based, for example, on the device's access policy. The access control unit 130 may operate, for example, in a round-robin mode, cycling through the devices sharing the memory The access control unit 130 may also operate, for example, in a semi-idle mode, waiting for a memory access request from a device. Upon receiving a memory access request from one or more devices, the access control unit 130 may grant access in the same order the requests were received or in order of device priority. The size and/or time of the access granted may be correlated to each device's associated memory access policy. Other operation modes, order of grant access, and access policies may be possible.

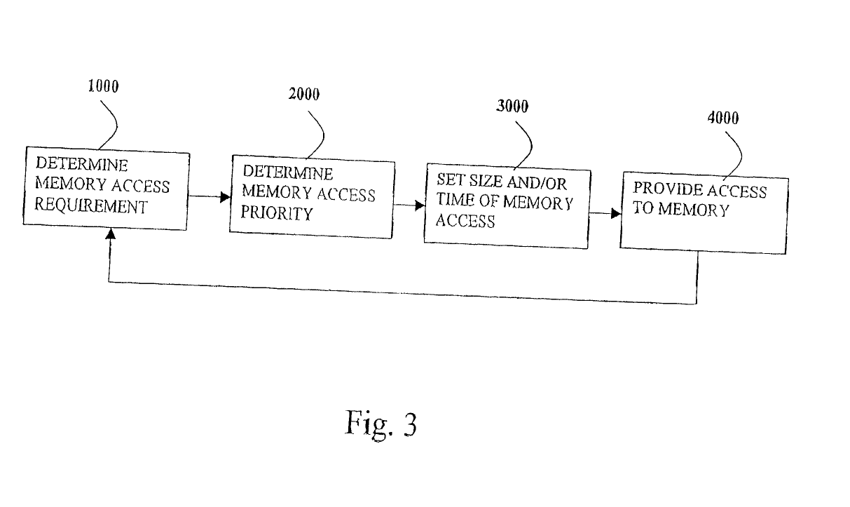

Turning now to FIG. 3, there is shown a method by which access may be granted to a shared memory according to an embodiment of the present invention, other steps or series of steps may be used. The memory access requirements of a device accessing the memory may be determined by either monitoring the device's request to read or write data to the memory, or by receiving some other indication from the device regarding its memory access requirements (block 1000). A device's memory access priority level may also be determined (block 2000). The device's memory access priority may relate to its function relative to other devices sharing the memory. Each device's priority may change based on the specific function it is performing. For example, the same device may have one priority for reading data from the memory and another for writing data to the memory.

Based on the memory access requirements and priority, a memory access size and/or time may be set (block 3000). Once a memory access policy is set for a device (block 3000), the device may be granted access to the memory (block 4000). The blocks of the method are repeated intermittently, either in the order shown or in any other order. The period between repeating blocks 1000 and 2000 may vary depending on the nature of the devices accessing the memory.

An embodiment of the present invention may, for example, use an arbiter with a set of counters to provide grant and release signals for every device to acquire the bus or memory interface. In an exemplary implementation of an embodiment, arbitration may be performed by look ahead access requests by devices or by using a pipeline, so the arbitration and actual assignment may be done concurrently. For each requesting device or requestor there may be a separate ratio counter. The ratio counter may be preset to a predefined value and may be decremented when its associated requestor is selected and finishes a memory transfer. The ratio counter may continue to be decremented until its value is zero, and the access to the memory may be passed to another requestor. When another requestor completes its transfer, the initial ratio counter's value may be reset to a value associated with its memory access requirements. The higher the requirements the higher would be the ratio counter value. Other methods of arbitration including other types of counters and end conditions are possible.

Directly below is an example of an algorithm which may be used in an embodiment of the present invention having ratio counters and where a CPU and other devices or requestors may share a common memory. Note that other suitable algorithms may be used.

Priority algorithm description

if(ratiocount_cpu >0 & !cpu_nonpri & cpu_sw)

priosel = cpu

else if(first_request& ratiocount (0)>0)

priosel = 0; //select first requestor

else if(second_request& ratiocount (1)>0)

priosel = 1; //select second requestor

else

priosel=cpu_fetch;//default is to enable the cpu to fetch commands

While certain features of the invention have been illustrated and described herein, many modifications, substitutions, changes, and equivalents will now occur to those skilled in the art. It is therefore, to be understood that the appended claims are intended to cover all such modifications and changes as fall within the true spirit of the invention.

What is claimed:

1. A shared memory access controller comprising:
a load monitor unit able to monitor memory access requests of devices operatively connected to a memory;
a load manager unit operatively connected to said load monitor unit and able to set an access policy for at least one of said devices correlated to data from said load monitor; and
an access control unit operatively connected to said load manager unit and able to provide the at least one of said devices access to said memory based on said access policy.

2. The controller according to claim 1, wherein said access policy is correlated to a priority level of the at least one of said devices.

3. The controller according to claim 1, wherein said access policy includes a memory access size value.

4. The controller according to claim 1, wherein said access policy includes a memory access time value.

5. A The controller according to claim 3, wherein at least one of said devices is an interface.

6. The controller according to claim 5, wherein at least one of said devices is a computing unit.

7. A method comprising regulating access to a shared memory by monitoring memory access requests for said memory by at least one device sharing said memory and by seeing an access policy for said device correlated to the load of monitored memory access requests.

8. The method according to claim 7, wherein setting said access policy comprises correlating said access policy to a priority level of said device.

9. The method according to claim 7, further comprising granting said device access to the memory in relation to said access policy.

10. The method according to claim 9, further comprising granting a device access to the memory in relation to an access requirement of said device.

11. The method according to claim 10, further comprising granting a device access to the memory in relation to an access requirement of said device relative to access requirements of at least one other device sharing the memory.

12. A system for storing digital data comprising:
a static random access memory;
a load monitor unit able to monitor memory access requests of devices operatively connected to said memory;
a load manager unit operatively connected to said load monitor unit and able to set an access policy for at least one of said devices correlated to data from said load monitor; and
an access control unit operatively connected to said load manager unit and able to provide the at least one device access to said memory based on said access policy.

13. The system according to claim 12, wherein said access policy is correlated to a priority level of the at least one of said devices.

14. The system according to claim 12, wherein said access policy includes a memory access size value.

15. The system according to claim 12, wherein said access policy includes a memory access time value.

16. The system according to claim 14, wherein at least one of the devices is an interface.

17. The system according to claim 16, wherein at least one of the devices is a computing unit.

18. A shared memory access controller comprising:
a load monitor unit able to monitor memory access requests of one or more devices operatively corrected to a memory;
a load manager unit operatively connected to said load monitor unit and able to set an access policy for at least one of said devices correlated to data from said load monitor and to a priority level of the at least one of said devices; and
an access control unit operatively connected to said load manager unit and able to provide the at least one of said devices access to said memory based on said access policy.

19. A method comprising:
regulating access to a shared memory by monitoring memory access requests for said memory by at least one device sharing said memory and by setting an access policy for said device correlated to the load of monitored memory access requests; and
granting said device access to said shared memory in accordance with said access policy.

20. A system for storing digital data comprising. a static random access memory;
a load monitor unit able to monitor memory access requests of devices operatively connected to said memory;
a load manager unit operatively connected to said load monitor unit and able to set an access policy for at least one of said devices correlated to data from said load monitor and to a priority level of the at least one of said devices; and
an access control unit operatively connected to said load manager unit and able to provide the at least one device access to said memory based on said access policy.
